(19) United States
(12) Patent Application Publication
(10) Pub. No.: US 2008/0150966 A1
(43) Pub. Date: Jun. 26, 2008

(54) Method and Apparatus for Scaling Graphics Images Using Multiple Surfaces

(75) Inventor: Yeqing Wang, Horsham, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/614,341

(22) Filed: Dec. 21, 2006

(51) Int. Cl. G09G 5/00

(52) U.S. Cl. 345/647

(57) ABSTRACT

An apparatus and method for scaling graphics images using multiple graphics pages or surfaces. The method includes separating an input graphics page into one or more distortion-nonsensitive video page portions and one or more distortion-sensitive video page portions, scaling the distortion-nonsensitive pages using a first scaling algorithm, scaling the distortion-sensitive page portions using a second (distortion-free) scaling algorithm, and compositing the scaled page portions. The apparatus includes a plurality of scalers to scale the distortion-nonsensitive video page portions using the first scaling algorithm and the distortion-sensitive video page portions using the second, distortion-free scaling algorithm. The apparatus also includes a compositor to combine scaled distortion-nonsensitive and scaled distortion-sensitive video page portions. The method and apparatus allow distortion-sensitive and distortion-nonsensitive information to be scaled separately, allowing distortion-free scaling to be performed on the distortion-sensitive information and conventional scaling to be performed on the distortion-nonsensitive information.

### BACKGROUND OF THE INVENTION

1. Field of the Invention

The invention relates to display information, such as video pages and graphics information. More particularly, the invention relates to methods and apparatus for scaling graphics display information.

2. Description of the Related Art

The aspect ratio of graphics displayed on a device, such as a television, is a numerical expression of the width to height of the graphics display. For standard television display format, e.g., National Television System Committee (NTSC) and Phase Alternation Line (PAL), the aspect ratio is 4:3, i.e., a “4” unit width corresponding to a “3” unit height, proportionally, regardless of the actual size of the screen. For wide screen digital television (DTV) formats for high definition television (HDTV) and some enhanced definition television (EDTV) formats, the aspect ratio is wider: 16:9, i.e., a “16” unit width corresponding to a “9” unit height, proportionally, regardless of the actual size of the screen. Also, with the availability of additional graphics functions, such as picture-in-picture functions and zoom-in functions, additional aspect ratios can be created for display.

Since there exists at least graphics information meant for display on devices with a 4:3 aspect ratio and graphics information meant for display on devices with a 16:9 aspect ratio, content providers and service providers often are faced with the task of providing graphics in two (or more) aspect ratio formats or converting graphics between different aspect ratio formats. Conventional methods for converting graphics typically require that a portion of the converted graphics information for display be removed or cut off. Some conventional conversion methods use linear conversion techniques to fill out the final display window or screen, however such methods introduce distortion to the graphics information. Moreover, distortion often is more pronounced with distortion-sensitive graphics information, such as logos, than it is with graphics information that is not as distortion-sensitive, such as text. Yet, conventional conversion techniques typically apply the same type or amount of aspect ratio conversion to all parts of the same graphics display information.

### BRIEF DESCRIPTION OF THE DRAWINGS

FIG. 1 is a block diagram of an apparatus for use in scaling graphics using multiple surfaces or pages;

FIG. 2 is a block diagram of another apparatus for use in scaling graphics using multiple surfaces or pages; and

FIG. 3 is a flow chart of a method for scaling graphics using multiple surfaces or pages.

### DETAILED DESCRIPTION

In the following description, like reference numerals indicate like components to enhance the understanding of the graphics scaling method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

Despite the many available methods and apparatus available to scale graphics images, e.g., to convert graphics images between various formats, such as between 4:3 and 16:9 aspect ratios, scaling graphics images often results in some distortion of the graphics image information. Since many viewers of graphics display devices, such as televisions and computer screen, are accustomed to viewing and reading different text fonts, a reasonable amount of distortion due to scaling for purposes of aspect ratio conversion can be tolerated by the viewer for this type of graphics information and similar types of graphics information. Such graphics information generally can be described as non-sensitive to distortion, or distortion-nonsensitive. However, graphics viewers, as well as graphics content providers and advertisers, often are very attentive to the distortion of other graphics content, e.g., logos and other non-text graphics items. Such graphics information generally can be described as distortion-sensitive. In general, a viewer typically is willing to accept more distortion with distortion-nonsensitive graphics information relative to the amount of distortion acceptable for distortion-sensitive graphics information.

As previously discussed, most graphics scaling and aspect ratio conversion methods and devices use linear scaling techniques, which typically scale all portions of the graphics images in the same manner to fill out the final display window or screen. That is, for purposes of scaling, e.g., for aspect ratio conversion and other format conversion, such methods and devices do not differentiate between different areas or portions of the graphics display or different types of graphic image information.

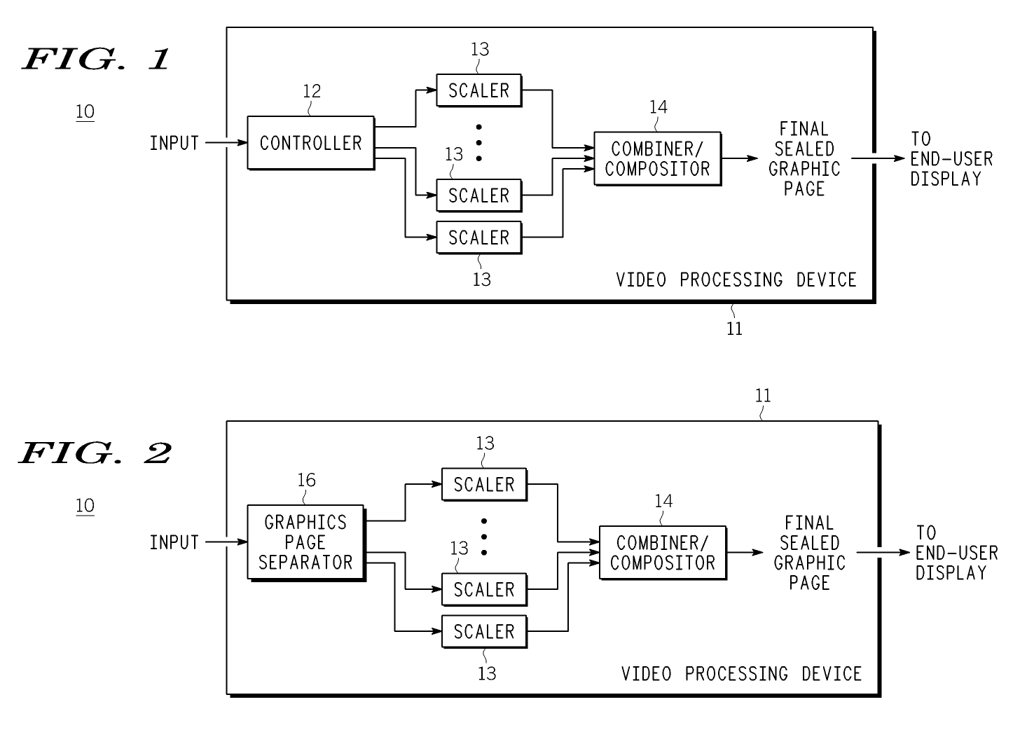

Referring now to FIG. 1, shown is a block diagram of an apparatus or device 10 for scaling graphics images using multiple graphics page portions or surfaces. The apparatus 10 can be completely or partially any suitable device or subsystem (or portion thereof) for receiving and/or processing graphics images, such as any signal converter or decoder (set-top) box or other suitable computing device or video processing device, including a residential gateway, an internet protocol (IP), satellite or cable digital video recorder, a computer, or a home media server system. All or a portion of the apparatus 10 can be comprised of any suitable structure or arrangement, e.g., one or more integrated circuits.

The apparatus 10 includes a video processing device 11 that has a controller 12, a plurality of scalers 13 and a combiner or compositor 14 coupled together as shown. Alternatively, the apparatus 10 also can include a graphics page separator 16 coupled between the input to apparatus 10 and the plurality of scalers 13, e.g., as shown in FIG. 2. One or more of the controller 12, the graphics page separator 16, the scalers 13 and the compositor 14 can be comprised completely or partially of any suitable structure or arrangement, e.g., one or more integrated circuits. Also, it should be understood that the apparatus 10 includes other components, hardware, and software (not shown) that are used for the normal operation of features and functions of the apparatus 10 not specifically described herein.

The apparatus 10 can be completely or partially configured in the form of hardware circuitry and/or other hardware components within a larger device or group of components. Alternatively, the apparatus 10 can be completely or partially configured in the form of software, e.g., as processing instructions or one or more sets of logic or computer code. In such configuration, the logic or processing instructions typically are stored in a data storage device (not shown), which typically is coupled to a processor or controller (not shown). The processor accesses the necessary instructions from the data storage device and executes the instructions or transfers the instructions to the appropriate location within the apparatus 10.

The apparatus 10 receives graphics information, such as graphics images, from an appropriate source (not shown) of graphics information, e.g., video information and/or graphics information generated locally from a device, such as a set-top box, or remotely from a service provider of video content that includes graphics images and possibly other graphics information. The service provider can be a television service provider (e.g., a national or local television network), a cable television service provider, an Internet content service provider, a satellite broadcast system service provider, or other suitable service provider. The apparatus 10 outputs information to an end-user display, which can be any suitable display device, such as a television or computer monitor.

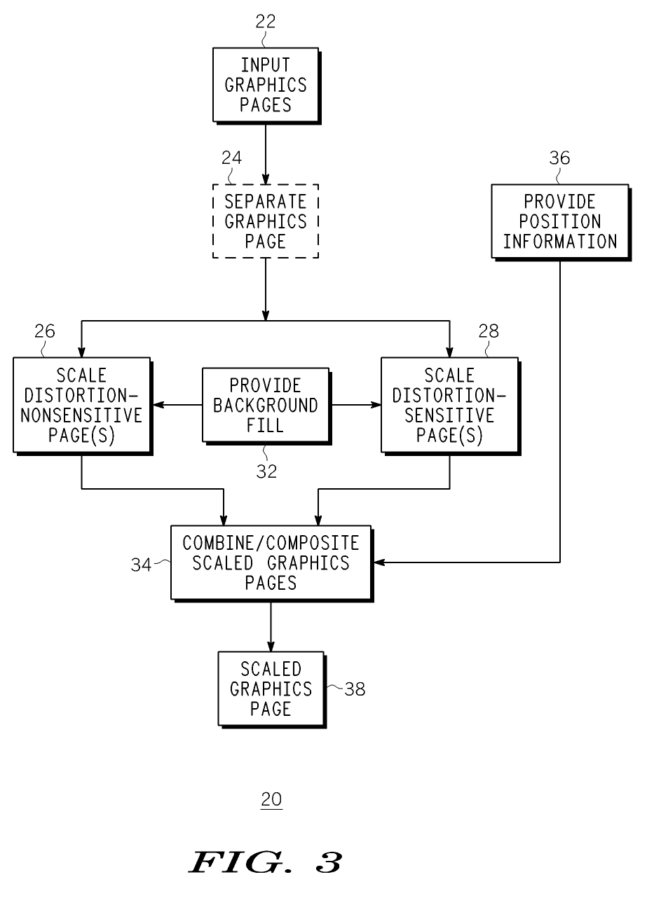

Referring now to FIG. 3, with continuing reference to FIG. 1 and FIG. 2, shown is a method 20 for scaling graphics using multiple surfaces or page portions. The method 20 will be described along with the operation of the apparatus 10. The method 20 includes the step 22 of inputting graphics images or graphics information into the apparatus 10. As discussed previously herein, the graphics information is input from a suitable source (not shown) that is operably connected to the apparatus 10.

Graphics information can be any information suitable for display on an end-user device, such as a television or computer monitor. For example, graphics information typically includes one or more pages, page components or portions, or surfaces of text and/or image information, such as one or more logos or other graphic items. The graphics information typically is displayed on top of or along with video stream content received by the apparatus 10 from the video content source, such as a video service provider. However, for purposes of discussion herein, graphics information also can be the video stream itself that is received by the apparatus 10 from the video content source. As discussed hereinabove, graphics information can include both distortion-sensitive information and distortion-nonsensitive information.

The method 20 includes the step 24 of separating the graphics information into a plurality of graphics pages, page portions, page components or surfaces. In general, video content from a video source is organized, stored and transmitted as a series of video pages or surfaces. A video page or surface typically is the amount of video information needed to generate one frame or screen of video data in a given video mode. As discussed, each screen of video information typically includes video content, but also can include one or more graphics items or images, such as a logo, and/or text.

The separating step 24 typically separates a video page or surface into one or more pages or page components of distortion-nonsensitive information and one or more pages or page components of distortion-sensitive information. For example, if a video page includes normal or distortion-nonsensitive video content along with two distortion-sensitive logos, the separating step 24 can separate the video page into a first page component of the distortion-nonsensitive video content, a second page component that includes the first distortion-sensitive logo, and a third page component that includes the second distortion-sensitive logo. Alternatively, in such an example, the separating step 24 can separate the video page into a first page component of the distortion-nonsensitive video content and a second page component that includes both the first distortion-sensitive logo and the second distortion-sensitive logo.

As discussed hereinabove, distortion due to format conversion, such as aspect ratio conversion, often is more pronounced in certain types of graphics information, such as logos and other graphic items like graphic images or image-based graphics. Such graphics information is referred to as distortion-sensitive graphics information or distortion-sensitive information. Alternatively, other graphics information, such as some text and text-based graphics, is not as susceptible to distortion from format conversion, such as aspect ratio conversion, at least in the mind of an end-user viewing such graphics information. Many end-users have become familiar with the many different types of texts and text fonts available. Thus, distortion due to format conversion in such information often is not noticed or at least does not appear as pronounced as distortion to distortion-sensitive information. Such graphics information is referred to as distortion-nonsensitive graphics information or distortion-nonsensitive information.

The separating step 24 can be performed in any suitable manner. For example, the separating step 24 can use any suitable type of recognition comparison function or functions to determine whether a video page includes logos or other graphics information that may be considered distortion-sensitive information. Alternatively, the video page or pages of interest may be encoded with metadata or other information, such as pixel addressing information, that aids in the possible identification and determination of distortion-sensitive information and/or distortion-nonsensitive information.

Also, other encoded information may be helpful in subsequently recreating an overall video page from the plurality of separated video pages once the separated video pages have been scaled, as will be discussed in greater detail hereinbelow. Such other information can include the color, format and alpha (transparency effect) of graphics information separated by the separating step 24. Also, such information can include the relative position of any distortion-sensitive items within a video page before and/or after the video page is separated.

The separating step 24 typically is performed prior to the graphics information being transmitted from the video source to the apparatus 10. In such case, the separating step 24 is performed by the content provider or the service provider, and the separated video is transmitted to the apparatus 10 in the form of one or more distortion-nonsensitive video pages or surfaces and one or more distortion-sensitive video pages or surfaces. Alternatively, the separating step 24 can be performed after the graphics information has been transmitted to the apparatus 10. In such case, the separating step 24 can be performed by the apparatus 10, e.g., by the graphics page separator 16.

The method 20 includes a first step 26 of scaling the distortion-nonsensitive video page(s) or page component(s) and a second step 28 of scaling the distortion-sensitive video page(s) or page component(s). Once the video page or surface has been separated into distortion-nonsensitive video page component(s) and distortion-sensitive video page component(s), individual or separate scaling operations can be performed on the separated video page components using one or more of the plurality of scalers 13. Such scaling operations can be controlled, at least initially, by the controller 12 or by the graphics page separator 16.

For example, the step 26 involves one of the scalers 13 scaling the distortion-nonsensitive video page using a first scaling algorithm. Since the distortion-nonsensitive video page component typically includes only distortion-nonsensitive graphics information, the scaler 13 can scale or convert the format of the video page component using any suitable format conversion. That is, the scaling step 26 can convert the distortion-nonsensitive video page from a first aspect ratio to a second aspect ratio. The results of the scaling step 26 produce a scaled or format-converted distortion-nonsensitive video page component.

If more than one distortion-nonsensitive video page component is created by the separating step 24, a corresponding plurality of scalers 13 can be used to each scale a video page component using the first algorithm. Alternatively, the plurality of distortion-nonsensitive video page components can be scaled using more than one first algorithm.

As discussed hereinabove, conventional converters, such as aspect ratio converters, use linear conversion processes, which often are not linear and thus often result in some distortion to the graphics information. Typically, linear conversion processes scale each dimension of the graphics information differently. However, since the video page component scaled by the first scaling step 26 includes only distortion-nonsensitive graphics information, distortion that is introduced as a result of the format conversion usually is not noticeable to an end user, or at least can be tolerated by the end-user. Thus, the scaling step 26 typically can use any suitable format conversion or aspect ratio conversion process.

Also, in the scaling step 28, one of the scalers 13 scales the distortion-sensitive video page component(s) using a second scaling algorithm. In this manner, the scaling step 28 can scale or convert the distortion-sensitive video page component(s) from a first aspect ratio to a second aspect ratio. The scaling step 28 produces one or more scaled or format-converted distortion-sensitive video pages or page component(s).

The scaling step 28 scales the distortion-sensitive video page component(s) using any suitable distortion-free scaling process or processes. Although most if not all scaling processes introduce at least some amount of distortion, the amount of distortion can be acceptable or tolerable to an average viewer. It should be understood that, for purposes of discussion herein, such scaling processes are referred to as distortion-free scaling processes. Generally, distortion-free scaling processes scale each dimension of the graphics information the same or similarly, thus introducing relatively little or no distortion.

Since the distortion-sensitive video page component(s) are sensitive to any scaling process that would introduce distortion, the second scaling algorithm and the scaling process involved should be such that the distortion-sensitive graphics information is not distorted. Thus, at least in this sense, the second scaling algorithm is different than the first scaling algorithm, which is used to scale distortion-nonsensitive video page component(s).

However, because the scaled distortion-sensitive page component(s) are to be combined or composited with the scaled distortion-nonsensitive video page component(s), the second scaling algorithm should be based on or take into consideration the first scaling algorithm. In this manner, the distortion-sensitive video page component(s) can be scaled, distortion-free, but in a manner that is proportional to the scaling or aspect ratio conversion of the distortion-nonsensitive video page component(s). For example, this will prevent a scaled logo from being too large (or too small) relative to the scaled distortion-nonsensitive graphics information when the scaled logo is combined or replaced in the scaled distortion-nonsensitive graphics page.

If more than one distortion-sensitive video page component is created by the separating step 24, a corresponding plurality of scalers 13 can be used to each scale a video page component using the second algorithm. The plurality of distortion-sensitive video page components can be scaled using more than one second scaling algorithm. However, if more than one second scaling algorithm is used, it should be understood that the second scaling algorithms can be different from one another, although they all should be suitable distortion-free scaling processes. A plurality of distortion-sensitive video page components is created if the input graphics page included more than one logo or other graphics item. In such case, the separating step 24 can create a separate video page or page component for each distortion-sensitive graphics item.

Alternatively, the distortion-sensitive video page component may not need to be scaled at all by the scaling step 28. A logo or other distortion-sensitive graphics item in a distortion-sensitive video sometimes is sized or otherwise configured in such a manner that it does not need to be scaled or converted. For example, if a distortion-sensitive video page is to be converted from a first aspect ratio to a second aspect ratio, but one or more graphics items (e.g., logos) on that distortion-sensitive page are of sufficient size regardless of which aspect ratio is to be used in the final composited video page, then the distortion-sensitive video page component may not need to be scaled.

Also, alternatively, a logo or other distortion-sensitive graphics item in a distortion-sensitive video sometimes is sized or otherwise configured in such a manner that it can or should be scaled by the same amount in a first direction and in a second direction that is orthogonal or perpendicular to the first dimension, e.g., both horizontally and vertically, even though the graphics item is a distortion-sensitive graphics item. For example, a logo that is symmetric in both the horizontal and vertical directions can be scaled by the same amount both horizontally and vertically to retain its symmetry.

The method 20 also can include a step 32 of providing a background fill to any portion of a video page or page component that may have been removed by the separating step 24. Such would be the case, e.g., if a logo or other distortion-sensitive graphics item was effectively removed from a video page by separating the video page into a distortion-nonsensitive video page or page component and a distortion-sensitive video page or page component.

The background fill providing step 32 typically provides image-neutral distortion-nonsensitive graphics information to one or more portions of the separated video page component, e.g., portions of the separated distortion-nonsensitive video page component where distortion-sensitive graphics items typically would be located. Image-neutral distortion-nonsensitive graphics information is the type of graphics information that does not contain images or other distortion-sensitive graphics information (i.e., image-neutral) and is not sensitive to distortion caused by format conversion (i.e., distortion-nonsensitive). For example, image-neutral distortion-nonsensitive graphics information is a single color.

The background fill may be performed if a logo or other distortion-sensitive graphics item that was removed from a video page is not scaled enough compared to the amount of scaling performed on the remaining video page from which the logo was effectively removed. In such case, the replaced logo would not be able to replace or fit over the area from which it was removed if the area from which it was removed is scaled by an amount greater than that of the logo. Therefore, the background fill will fill in the areas that may not be able to be filled by the scaled logo when the scaled logo is replaced in the scaled video page.

As shown, the background fill providing step 32 can provide image-neutral distortion-nonsensitive graphics information to the distortion-nonsensitive pages or page component(s) and/or the distortion-sensitive pages or page component(s). The background fill step 32 typically is performed after the separating step 24 and before one or both of the scaling steps 26, 28. However, the background fill step 32 can be performed after one or more of the scaling steps 26, 28.

The method 20 also includes the step 34 of compositing or combining the scaled distortion-nonsensitive page(s) or page component(s) and the distortion-sensitive page(s) or page component(s). Compositing is a conventional process in which different portions or components of a graphics image or a graphics page are combined. The graphics combiner or compositor 14 performs the compositing step 34 to effectively replace the distortion-sensitive graphics items (e.g., logos) that previously were removed by the step 24 of separating the input graphics page into distortion-nonsensitive graphics page component(s) and distortion-sensitive graphics page component(s). However, because of the first scaling step 26, the compositing step 34 is compositing distortion-nonsensitive graphics page component(s) that have been scaled or format converted, e.g., converted from one aspect ratio to another aspect ratio. Also, because of the second scaling step 28, the compositing step 34 also is compositing distortion-sensitive graphics page component(s) that may have been scaled or format converted, but in a manner that does not distort the distortion-sensitive graphics information.

Therefore, in this manner, the method 20 allows graphics information that is not as sensitive to distortion to be converted from one aspect ratio to another, e.g., in a conventional manner, regardless of whether the conversion introduces distortion. Yet, graphics information that typically would suffer more from distortion, such as logos and other graphics items or image-based graphics, can be scaled or resized in a manner proportional to the aspect ratio conversion of the distortion-nonsensitive graphics information, but without incurring distortion that often is introduced by many conventional scaling processes and aspect ratio conversion processes. Therefore, the portion of the graphics information that would suffer more from distortion is not distorted, yet all of the graphics information (both distortion-sensitive and distortion-nonsensitive) is effectively scaled or format converted, e.g., from one aspect ratio to another aspect ratio.

The compositing step 34 can include recalculating the position (or determining a new position) of the scaled distortion-sensitive graphics items before combining the video page component(s) containing such graphics information with other video page component(s), such as the distortion-nonsensitive video page component(s). As discussed previously herein, one or more of the input graphics pages may be encoded with metadata or other information that determines or notes the relative position of one or more graphics items within a given video page. Thus, the method 20 can include a step 36 of providing such position information to the compositor 14. Based on this position information, along with the first and second scaling algorithms, the compositor 14 can determine a new position, if necessary, of the scaled distortion-sensitive graphics items when compositing the scaled distortion-sensitive video page component(s) and the scaled distortion-nonsensitive video page component(s).

Therefore, the compositing step 34 can reposition a graphics item, such as a logo, in the same relative position within a video page or surface, with the same relative scaling, but without any distortion that otherwise may have been caused by conventional format conversion processes, such as aspect ratio conversion. The basis for the new position of the graphics item can include its initial position within the initial video page or within a distortion-sensitive video page, the amount of scaling to the distortion-nonsensitive video page (including the first scaling algorithm), and/or the amount of scaling to the distortion-sensitive video page (including the second scaling algorithm).

Once the compositing step 34 has been performed, the method 20 produces 38 a scaled video or graphics page containing scaled graphics image information without distortion to the logos or other distortion-sensitive graphics items.

It should be understood that the scaling processes, methods, components and devices described herein involve scaling or converting graphics images between various formats. Therefore, scaling or converting graphics images can be performed in a manner that either increases or decreases the size of the graphics images. That is, graphics images can be scaled or converted from a first, smaller size to a second, larger size. Alternatively, graphics images can be scaled or converted from a first, larger size to a second, smaller size.

The method shown in FIG. 3 may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the graphics scaling method and apparatus herein described without departing from the spirit and scope of the invention as defined by the appended claims and their full scope of equivalents.

1. A computer program embodied in a computer-readable medium for scaling a graphics image, the graphics image including at least one portion of a distortion-sensitive graphics page and at least one portion of a distortion-nonsensitive graphics page, the program comprising:
instructions for scaling the at least one distortion-nonsensitive graphics page portion using a first scaling algorithm to produce at least one scaled distortion-nonsensitive graphics page portion;
instructions for scaling the at least one distortion-sensitive graphics page portion using a second scaling algorithm to produce at least one scaled distortion-sensitive graphics page portion, wherein the second scaling algorithm is a distortion-free scaling algorithm,
wherein the first scaling algorithm is different than the second scaling algorithm; and
instructions for compositing the at least one scaled distortion-nonsensitive graphics page portion and the at least one scaled distortion-sensitive graphics page portion to produce a scaled graphics image.

2. The computer program as recited in claim 1, wherein the distortion-sensitive graphics page portion includes at least one graphic item, wherein the instructions for scaling the at least one distortion-sensitive graphics page portion includes instructions for scaling the at least one graphic item, and wherein the compositing instructions include instructions for positioning the scaled graphic item into the scaled graphics image.

3. The computer program as recited in claim 2, wherein the graphics image has associated therewith position information for determining the position of the at least one graphic item on the distortion-sensitive graphics page, and wherein the instructions for positioning the scaled graphic item into the scaled graphics image is based on the position information.

4. The computer program as recited in claim 2, wherein the instructions for positioning the scaled graphic item into the scaled graphics image is based on at least one of the scaling of the at least one distortion-nonsensitive graphics page portion and the scaling of the at least one distortion-sensitive graphics page portion.

5. The computer program as recited in claim 1, further comprising instructions for separating the graphics image into at least one distortion-sensitive graphics page portion and at least one distortion-nonsensitive graphics page portion.

6. The computer program as recited in claim 5, wherein the distortion-sensitive graphics page portion includes at least one graphic item, wherein the separating instructions include instructions for determining the location of the at least one graphic item on the graphics image, wherein the instructions for scaling the at least one distortion-sensitive graphics page portion includes instructions for scaling the at least one graphic item, and wherein the compositing instructions include instructions for positioning the scaled graphic item into the scaled graphics image based on the determined location of the at least one graphic item.

7. The computer program as recited in claim 5, further comprising instructions for providing image-neutral distortion-nonsensitive graphics information to the at least one distortion-nonsensitive graphics page portion.

8. A computer program embodied in a computer-readable medium for converting a graphics image from a first aspect ratio to a second aspect ratio, the graphics image including at least one distortion-sensitive graphics page portion and at least one distortion-nonsensitive graphics page portion, the program comprising:
instructions for converting the at least one distortion-nonsensitive graphics page portion from the first aspect ratio to the second aspect ratio;
instructions for converting the at least one distortion-sensitive graphics page portion from the first aspect ratio to the second aspect ratio; and
instructions for compositing the at least one scaled distortion-nonsensitive graphics page portion and the at least one scaled distortion-sensitive graphics page portion to produce a scaled graphics image.

9. The computer program as recited in claim 8, wherein the at least one distortion-sensitive graphics page portion has a first dimension and a second dimension orthogonal to the first dimension, and wherein the instructions for converting the at least one distortion-sensitive graphics page portion from the first aspect ratio to the second aspect ratio includes scaling the first dimension of the at least one distortion-sensitive graphics page portion and the second dimension of the at least one distortion-sensitive graphics page portion by the same amount.

10. The computer program as recited in claim 8, wherein the distortion-sensitive graphics page portion includes at least one graphic item, wherein the graphics image includes position information for determining the position of the at least one graphic item on the graphics image, and wherein the instructions for positioning the scaled graphic item into the scaled graphics image is based on at least one of the scaling of the at least one distortion-nonsensitive graphics page portion and the scaling of the at least one distortion-sensitive graphics page portion.

11. The computer program as recited in claim 8, wherein the distortion-sensitive graphics page portion includes at least one graphic item, wherein the graphics image includes position information for determining the position of the at least one graphic item on the graphics image, and wherein the compositing instructions include instructions for positioning the graphic item into the scaled graphics image based on the determined location of the at least one graphic item.

12. The computer program as recited in claim 8, further comprising instructions for separating the graphics image into at least one distortion-sensitive graphics page portion and at least one distortion-nonsensitive graphics page portion.

13. The computer program as recited in claim 8, wherein one of the first aspect ratio and the second aspect ratio further comprises a 4:3 aspect ratio and the other of the first aspect ratio and the second aspect ratio further comprises a 16:9 aspect ratio.

14. A device for scaling a graphics image, the graphics image including at least one distortion-sensitive graphics page portion and at least one distortion-nonsensitive graphics page portion, comprising:
a first scaler for scaling the distortion-nonsensitive graphics page portion using a first scaling algorithm to produce a scaled distortion-nonsensitive graphics page portion;
a second scaler for scaling the distortion-sensitive graphics page portion using a second scaling algorithm to produce a scaled distortion-sensitive graphics page portion,
wherein the second scaling algorithm is different from the first scaling algorithm; and
a combiner for compositing the scaled distortion-sensitive graphics page portion and the scaled distortion-nonsensitive graphics page portion to produce scaled graphics image.

15. The device as recited in claim 14, further comprising a graphics page separator for separating the graphics image into at least one distortion-sensitive graphics page portion and at least one distortion-nonsensitive graphics page portion.

16. The device as recited in claim 14, wherein at least one of the first scaler, the second scaler and the combiner is implemented in software executed by a computer.

17. The device as recited in claim 14, wherein at least one of the first scaler, the second scaler and the combiner is implemented in hardware.

18. The device as recited in claim 14, wherein at least a portion of the device further comprises an integrated circuit.

19. The device as recited in claim 14, wherein at least a portion of the device is contained in a graphics processing device.

20. The device as recited in claim 19, wherein the graphics processing device is selected from the group consisting of a signal converter box, a signal decoder box, a digital video recorder, a computer, and a home media server.
